(19) United States
(12) Patent Application Publication
(10) Pub. No.: US 2005/0067504 A1
(43) Pub. Date: Mar. 31, 2005

(54) Mist evaporating device and method

(76) Inventor: Mark Naedler, Houston, TX (US)

Correspondence Address: Loren G. Helmreich;Browning Bushman, P.C., Suite 1800, 5718 Westheimer, Houston, TX, 77057, US

(21) Appl. No.: 10/951,133

(22) Filed: Sep. 27, 2004

Related U.S. Application Data
(60) Provisional application No. 60/507,336, filed on Sep. 30, 2003.

(51) Int. Cl. B05B 1/34

(52) U.S. Cl. 239/381; 239/380

(57) ABSTRACT

The water misting system includes a stationary member 3, 4 having a flow path therein for transmitting water, the rotary swivel 5 in fluid communication with the stationary member, and one or more conduits 6, 7 in communication with the stationary member and extending radially outward from the swivel. A misting nozzle 8, 9 is provided at an outer end of each respective conduit, and has a central nozzle axis angled with respect to a central axis of a respective conduit for discharging mist while producing a tangential thrust for rotating the one or more conduits and the misting nozzle about the stationary member. According to the method of the invention, angling of the central nozzle axis of each misting nozzle with respect to a central axis of the respective conduit produces the tangential thrust to rotate the conduits and thereby mist a large area.

### RELATED CASE

The present application claims priority from U.S. Ser. No. 60/507,336 filed on Sep. 30, 2003.

### FIELD OF THE INVENTION

The present invention relates to devices for misting water to provide improved comfort to people in the area of the misting device. More particularly, the invention relates to a misting device and method which is relatively simple and provides misting to a large area.

### BACKGROUND OF THE INVENTION

Evaporation of water with the use of misting nozzles has become a popular method for cooling outdoor areas. An arid atmosphere rapidly evaporates water and this effectively lowers the temperature of the air. In more humid climates, the evaporation rate is not as rapid and a water mist can sometimes make the area uncomfortably damp.

Simple misting systems usually include many stationary nozzles held above the area where cooling is desired. Unless there is significant wind, this can create a showerhead effect. Areas directly beneath the nozzles become wet and areas between the nozzles might not realize any cooling. It is preferred to divide the total flow rate of the water needed for the area into as many small misting nozzles as possible to distribute mist evenly. Small nozzles are prone to clogging.

Previously designed misting systems have sought to improve evaporation by placing the misting nozzles in the path of an electrically driven fan. This method is very effective at lowering the air temperature, but is noisy and will not necessarily provide all individuals in an area with a consistent environment. Those in the path of the fan may receive excessive moisture and cooling, and those out of the path might not feel the effect. The presence of water from the misters can add danger to the use of electricity powering the fan. Often poolside patios are the location for misting systems, and the use of electric fans is undesirable. Fans are also noisy and can be an annoyance.

The disadvantages of the prior art are overcome by the present invention and an improved misting device and method are hereinafter disclosed.

### SUMMARY OF THE INVENTION

The present invention simply and safely improves the evaporation rate from a misting nozzle, as well as improves the comfort of individuals in the area. In one embodiment, a rotary assembly is capable of passing pressurized fluid from its stationary center to a number of tubes attached to its rotating exterior. The tubes can transport the fluid radially outward to attached misting nozzles. The misting nozzles travel in a circumference substantial enough to carry the water around a large area, blending the mist with churning fresh new air as the tubes rotate. The rotary assembly could be power with an external source, but preferably utilizes the thrust energy from the pressurized fluid to propel the tubes. The present invention may include a floor stand and a tall telescoping pole to allow for vertical adjustment of the tubes over an area to add distance between the nozzles and the individuals to improve evaporation if necessary. A quick-disconnecting rotary assembly is provided for easy storage.

### BRIEF DESCRIPTION OF THE DRAWINGS

FIG. 1 illustrates a quickly detachable rotary assembly supported by a floor stand having a telescoping pole.

FIG. 2 is a top view of FIG. 1.

FIG. 3 is a cross-sectional detail of the rotary assembly.

FIG. 4 is a detail of the telescoping assembly.

FIG. 5 illustrates the misting unit anchored to a ceiling.

### DESCRIPTION OF THE ILLUSTRATED EMBODIMENTS

A preferred embodiment employs a principle found in many sprinkler and irrigation systems. These sprinkler system designs include thrust driven tubes rotating about a rotary connection to spray water over an area, but are not powered by misting nozzles intended for evaporating the water. Instead, these sprinkler systems rely on the trajectory of the water's stream to distribute water over the vast area the water irrigates. The rotating tubes primarily provide a means of changing the stream's direction to distribute the water evenly over a circular area and do not carry the water a significant distance from the sprinkler's axis. Evaporation is not desired from these watering devices.

A good misting nozzle deliberately disrupts the cohesiveness of the water's stream (absence of a cohesive stream) and aerates the water as much as possible. This destroys the water's trajectory and thrusting efficiency. It also limits the distance the water will project without the assistance of wind to only a few feet. This condition is why the rotating tubes carry the water to the outer perimeter of the area to be cooled. Rotating a misting nozzle about an axis on a very short tube is preferable over a stationary nozzle since it mixes with air 360 degrees around the nozzle. Using a long arm to carry the nozzle discharges the mist to far areas with fresh, unsaturated air, distributing the mist a great distance.

The nozzle's thrust as a means to rotate the assembly removes the need for an external source of power. The rotational speed of the device is determined by several significant factors: the pressure of the fluid before leaving the nozzle, the angle at which the nozzle is directed to provide some degree of tangential thrust, the geometry of the misting nozzle, and frictional factors. The flow rate is not a significant factor when the frictional factors are a small percentage. One of the forces governing the device's speed is the acceleration of the water itself. As the flow rate increases, so does the mass of the fluid that is gaining kinetic energy from the device. Increasing the length of the tube improves the mechanical advantage of the nozzle's thrust to help rotation, but the rotational speed will slow down since the water's kinetic energy is limited and the water's velocity at the larger radius can only be maintained if the rotational speed slows down. Adding length to the tubes does reduce the percentage of drag presented by the mechanical friction in the rotary union.

The rotary union of the invention is designed to provide as little friction as possible. A very small diameter rotary seal minimizes the torque it applies. Thrust roller bearings are used to carry the weight of the rotating section to lessen bearing drag. The bearings are placed above the rotary seal and drainage is provided beneath the rotary seal so that in the event of a rotary seal leak, the bearings will not be exposed to contamination. The tubes are as light-weight as possible to avoid significant rotational inertia that could be hazardous.

An improved system to evaporate mist and hence cool the air is provided. It does not require electricity to have the moving air assist in evaporation. The flow rate through the nozzles can be much larger than stationary nozzles since the nozzles are carried over a large distance and will not saturate a single spot. Larger nozzles require less maintenance since they are less susceptible to contamination and calcification. The silently moving tubes blend the mist with the air so more humid environments can also achieve evaporation cooled air.

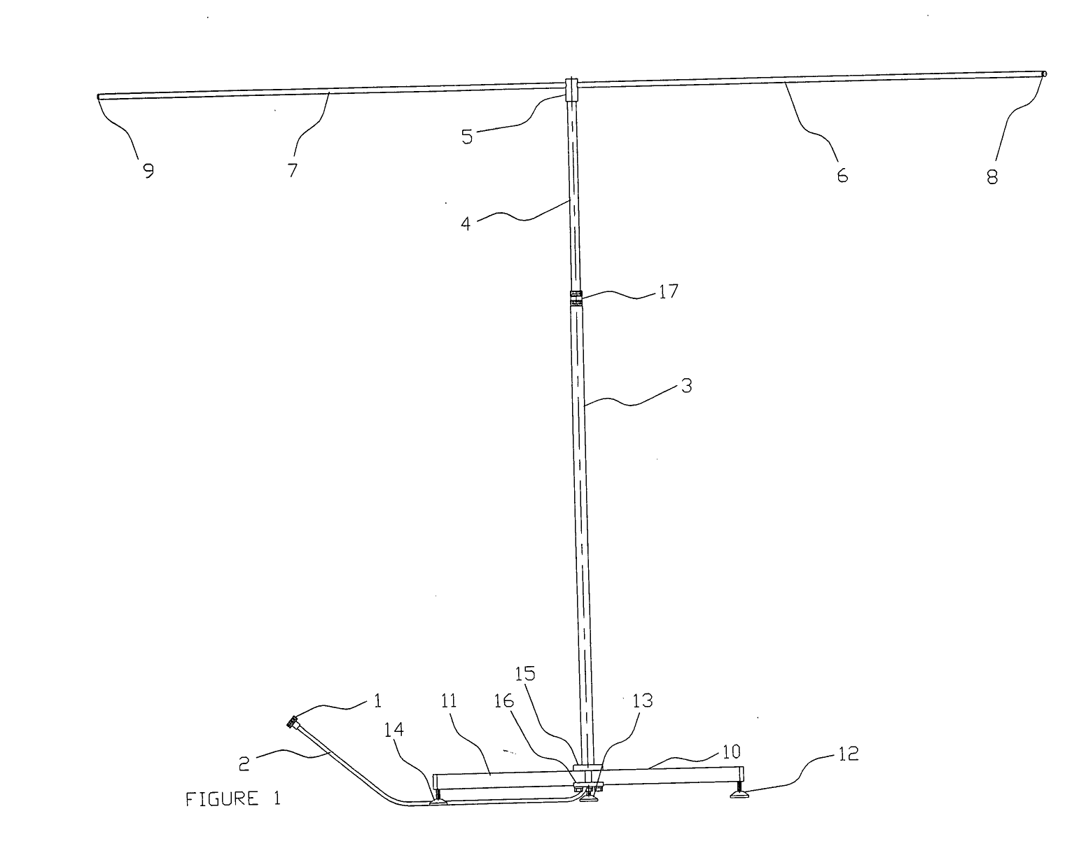

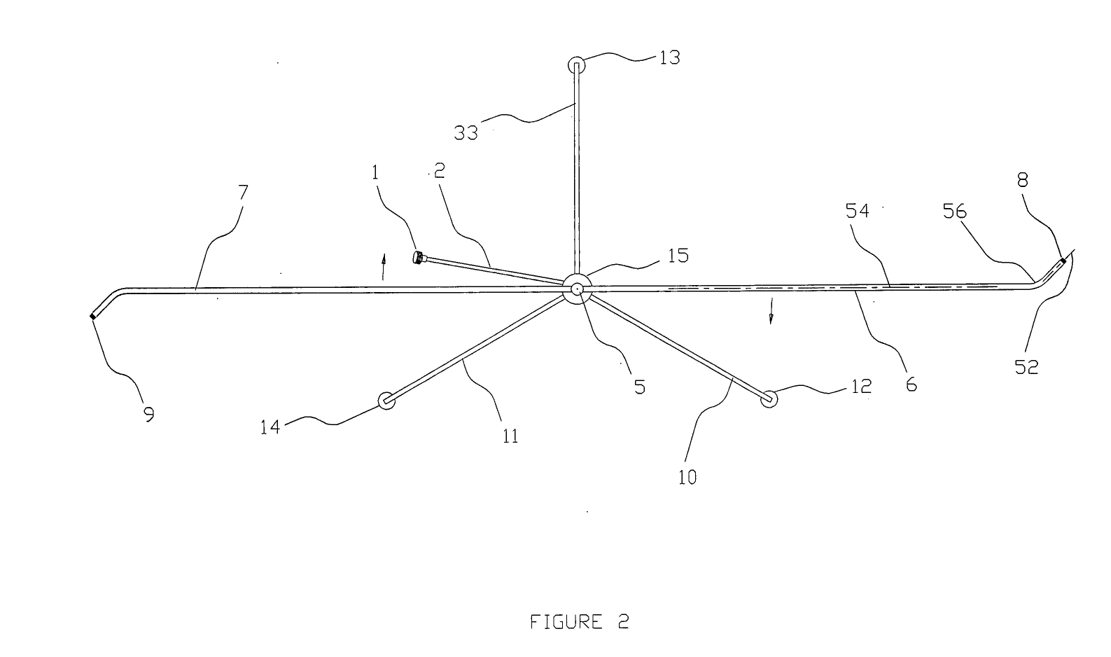

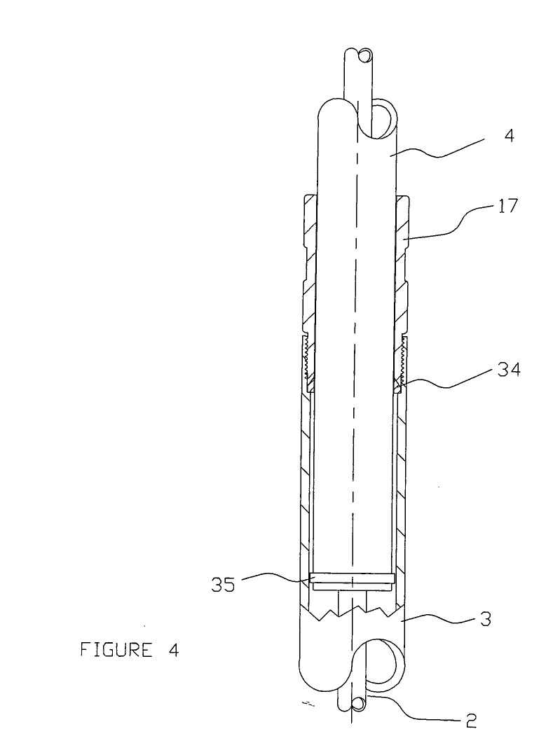

With reference now to the detail of the drawings, FIGS. 1 and 2 illustrate a floor stand assembly utilizing the invention. A source of pressurized water is attached to the fluid connector 1. The hose 2 carries the pressurized water through the hollow poles 3 and 4, and passes the water into the rotary assembly 5. The rotary assembly transfers the water from its stationary section connected to pole 4 to its rotating section, which carries radial tubes 6 and 7. Radial tubes 6 and 7 are bent at their outer ends toward tangent vectors on their rotary plane so that misting nozzles 8 and 9 deliver thrust capable of propelling the tubes into rotary motion. Each misting nozzle has a central nozzle axis 52 angled with respect to a horizontal axis 54 of the conduit 6, 7 which does not include the bent portion 56. Since the stationary member 3, 4 is preferably substantially vertical, each bent portion 56 includes a substantially horizontal component to produce the desired thrust. The bent portion may thus reside in a substantially horizontal plane, or may be angled, e.g., at 30°, relative to the horizontal plane. The bent portion 56 is preferably angled at from 20° to 90° in a horizontal plane relative to the axis 54 to produce the desired thrust. The bent portion 56 thus includes a horizontal bend component to produce thrust for rotation, and may also include a vertical bend component to discharge mist upward or downward, as desired. A wedging screw 17 is threadably connected to the base pole 3. The mechanism 17 illustrated in FIG. 4 allows pole 4 to slide within pole 3 and to hold pole 3 at various elevations when the wedging screw 17 is tightened. The base pole 3 is attached to bottom plates 15 and 16. A top view of this design is illustrated in FIG. 2.

FIG. 2 illustrates the axis of rotary assembly 5 and the direction of spin tubes 6 and 7 will take when the device is pressurized. The angle at which nozzles 8 and 9 are bent towards the tangent of the traveled circumference can be varied depending on the desired speed of rotation. The base includes three legs 10,11 and 33 that are fastened to base plates 15 and 16. Adjustable leveling glides 12, 13 and 14 are positioned at the end of the legs to support the structure.

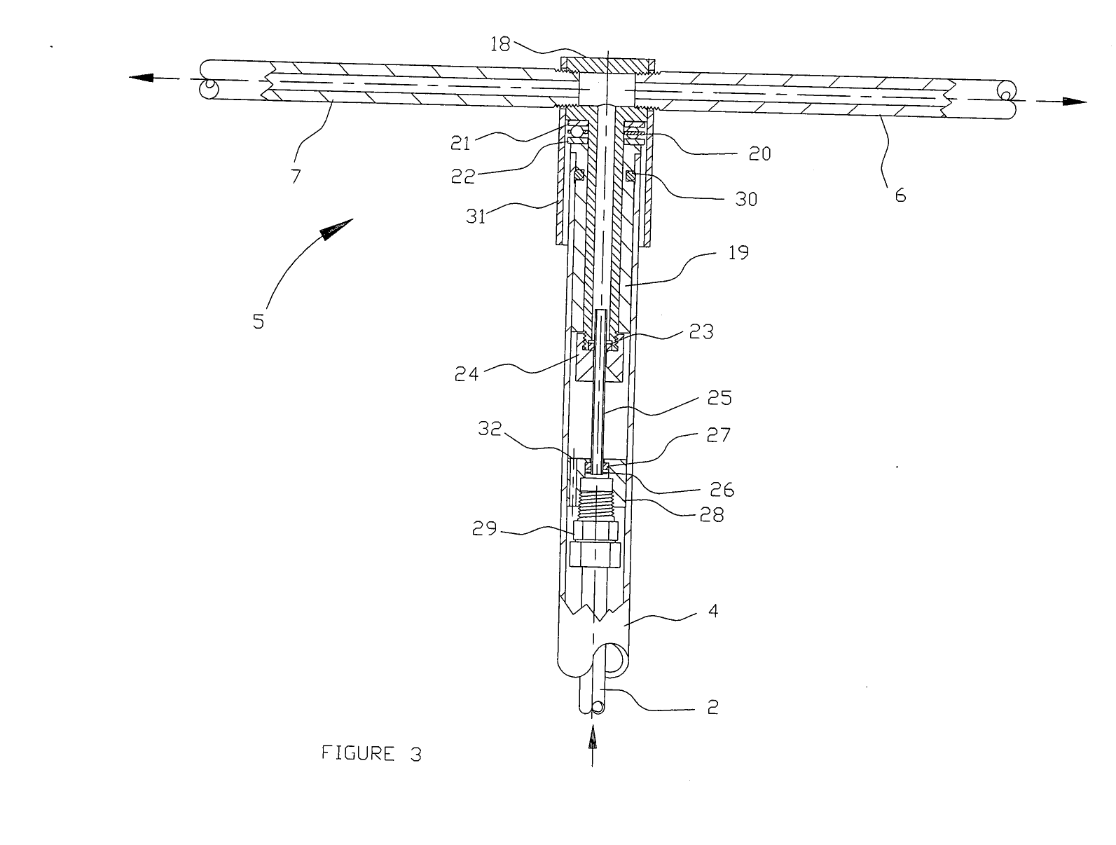

FIG. 3 is a cross sectional detail of the rotary assembly 5. This is one possible rotary connection to provide low friction rotary motion. Hose 2 delivers pressurized water to the rotary assembly's 5 stationary member 28 housed within pole 4 through a fluid connector 29. Stationary member 28 is sealably connected to connector 29 with a pipe thread engagement. Stationary member 28 houses a circular seal ring 27 that provides a sealable connection between tube 25 and stationary member 28. Flange 26 prevents tube 25 from being forced downstream from seal 27. A second circular seal 23 receives the other end of tube 25 and provides a sealable connection between tube 25 and rotary member 18. Cap nut 24 retains seal 23 within rotary member 18. When rotary member spins in relation to stationary member 28, the seals 23 and 27 can be designed so that one or both rotate in relation to tube 25. Bushing 19 holds rotary member 18 on a stable axis. The roller thrust-bearing 20 rides on hardened washers 21 and 22 to support the one or more conduits and reduce friction between rotary member 18 and bushing 19. Tubes 6 and 7 are sealably connected to rotary member 18 with pipe threads in this case. Flexible ring or snap connection 30 snaps into a groove with pole 4 to allow quick attachment and detachment of the rotary assembly from the stationary components. Cap nut 24 has a bell-mouth for receiving tube 25 when reconnecting the rotating pieces to pole 4. Shield 31 prevents dirt and water from contaminating bearings 20 and bushing 19. A drain passage 32 is provided to allow water that might leak from the sealing rings 23 and 27 to pass away from the bearings 20.

FIG. 4 illustrates a cross-section of a telescoping mechanism to act between poles 3 and 4. Hollow wedging screw 17 drives the ring wedge 34 into pole 4 when wedging screw 17 is threadably tightened into pole 3. A shoulder within pole 3 prevents ring wedge 34 from axial movement and the mating tapered faces on wedging screw 17 and ring wedge 34 convert the axial force from wedging screw 17 into a radial force pressing ring wedge 34 into pole 3. Bushing 35 holds pole 3 coaxially within pole 4. Many existing methods can be used to secure pole 3 at various positions within pole 4.

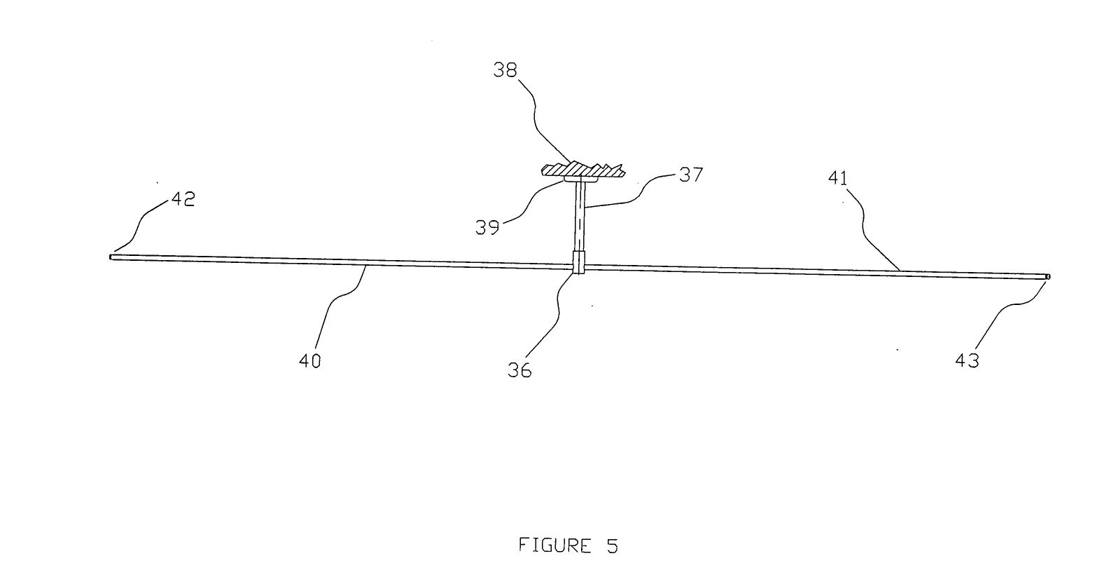

FIG. 5 illustrates an overhead mount design utilizing the invention. Tubes 40 and 41 are sealably connected to rotary assembly 36. The rotary assembly 36 receives pressurized fluid from an external source. Misting nozzles 42 and 43 are secured at the ends of tubes 40 and 41 and are in communication with the pressurized fluid held within tubes 40 and 41. The nozzles 42 and 43 are positioned so that they produce tangential thrust in relation to the circumference they travel. Post 37 suspends the rotary assembly 36 above the area to be cooled. Bracket 39 anchors post 37 to a ceiling or beam 38.

In a preferred embodiment, the rotary swivel assembly 5 is provided at the end of the stationary member, and between the stationary member and the one or more conduits. In another embodiment, the rotary swivel could be provided in the middle or at the end of the stationary member spaced from the one or more conduits, so that both part of the stationary member and the conduits are rotated about the swivel. Also, the embodiment depicted discloses two conduits in fluid communication with the stationary member and extending radially outward from the rotary swivel. In another embodiment, additional conduits could be provided equally spaced circumferentially about the stationary member, or a single conduit could be provided for delivering water to one or more misting nozzles.

According to the method of the invention, the substantially vertical member is provided as disclosed herein having a flow path for transmitting water. A rotary swivel is provided in fluid communication with the vertical member, and one or more conduits are provided each in fluid communication with the vertical member and extending radially outward from the rotary swivel. One or more misting nozzles are each mounted at an outer end of a respective conduit, with each misting nozzle receiving water from a respective conduit and having a central axis angled with respect to a central axis of a respective conduit for discharging mist while producing a tangential thrust for rotating the one or more conduits and the misting nozzles about the vertical member. A stationary member may include a telescoping pole, such that the height of the one or more misting nozzles may be adjusted, or the vertical member may extend downward from an overhead mount.

Although specific embodiments of the invention have been described herein in some detail, this has been done solely for the purposes of explaining the various aspects of the invention, and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

1. A water misting system, comprising:
a stationary member having a flow path therein for transmitting water;
a rotary swivel in fluid communication with the stationary member;
one or more conduits each in fluid communication with the stationary member and extending radially outward from the rotary swivel; and
one or more misting nozzles each at an outer end of a respective conduit, each misting nozzle receiving water from a respective conduit and having a central nozzle axis angled with respect to a central axis of a respective conduit for discharging mist while producing a tangential thrust for rotating the one or more conduits and misting nozzles about the stationary member.

2. A water misting system as defined in claim 1, wherein each of the one or more conduits includes a radially outward bent portion for angling a respective nozzle.

3. A water misting system as defined in claim 1, wherein the rotary swivel includes a roller thrust bearing to support the one or more conduits.

4. A water misting system as defined in claim 1, wherein the stationary member includes a telescoping pole, such that the height of the one or more misting nozzles may be adjusted.

5. A water misting system as defined in claim 1, further comprising:
a base for supporting the stationary member, the base including at least three legs.

6. A water misting system as defined in claim 1, wherein the stationary member includes a connector for fluid interconnection with a water hose.

7. A water misting system as defined in claim 1, further comprising:
a snap connection for attaching and detaching the rotary swivel from the stationary member.

8. A water misting system as defined in claim 1, wherein the stationary member extends downward from an overhead mount.

9. A water misting system, comprising:
an elongate substantially vertical member having a flow path therein for transmitting water;
a rotary swivel in fluid communication with the elongate member;
one or more conduits each in fluid communication with the elongate member and extending radially outward from the rotary swivel, each of the one or more conduits including a radially outward bent portion; and
one or more misting nozzles each at an outer end of the bent portion of a respective conduit, each misting nozzle receiving water from a respective conduit and having a central nozzle axis angled with respect to a central axis of a respective conduit for discharging mist while producing a tangential thrust for rotating the one or more conduits and misting nozzles about the elongate member.

10. A water misting system as defined in claim 9, wherein the rotary swivel includes a roller thrust bearing to support the one or more conduits.

11. A water misting system as defined in claim 9, wherein the elongate member includes a telescoping pole, such that the height of the one or more misting nozzles may be adjusted.

12. A water misting system as defined in claim 9, further comprising:
a base for supporting the elongate member, the base including at least three legs.

13. A water misting system as defined in claim 9, further comprising:
a snap connection for attaching and detaching the rotary swivel from the stationary member.

14. A method of misting air with water, comprising:
providing a substantially vertical member having a flow path therein for transmitting the water;
providing a rotary swivel in fluid communication with the vertical member;
providing one or more conduits each in fluid communication with the vertical member and extending radially outward from the rotary swivel; and
mounting one or more misting nozzles each at an outer end of a respective conduit, each misting nozzle receiving water from a respective conduit and having a central nozzle axis angled with respect to a central axis of a respective conduit for discharging mist while producing a tangential thrust for rotating the one or more conduits and misting nozzles about the vertical member.

15. A method as defined in claim 14, wherein each of the one or more conduits includes a radially outward bent portion for angling a respective nozzle.

16. A method as defined in claim 14, wherein the rotary swivel includes a roller thrust bearing to support the one or more conduits.

17. A method as defined in claim 14, wherein the stationary member includes a telescoping pole, such that the height of the one or more misting nozzles may be adjusted.

18. A method as defined in claim 14, further comprising:
providing a base for supporting the stationary member, the base including at least three legs.

19. A method as defined in claim 14, further comprising:
providing a snap connection for attaching and detaching the rotary swivel from the stationary member.

20. A method as defined in claim 14, wherein the vertical member extends downward from an overhead mount.
